(19) United States
(12) Patent Application Publication
(10) Pub. No.: US 2009/0033615 A1
(43) Pub. Date: Feb. 5, 2009

(54) LIGHT EMISSION DEVICE, DISPLAY USING THE LIGHT EMISSION DEVICE, METHOD OF DRIVING THE LIGHT EMISSION DEVICE, AND METHOD OF DRIVING THE DISPLAY

(76) Inventors: Duck-Gu Cho, Suwon-si (KR); Sang-Jin Lee, Suwon-si (KR); Ji-Won Lee, Suwon-si (KR)

Correspondence Address: CHRISTIE, PARKER & HALE, LLP, PO BOX 7068, PASADENA, CA, 91109-7068, US

(21) Appl. No.: 11/967,921

(22) Filed: Dec. 31, 2007

(30) Foreign Application Priority Data
Aug. 2, 2007 (KR) 10-2007-0077724

(51) Int. Cl. G09G 3/36

(52) U.S. Cl. 345/102

(57) ABSTRACT

A light emission device, a display using the light emission device, and a method of driving the light emission device are provided. The light emission device includes a plurality of scan lines for transmitting a plurality of scan signals, a plurality of column lines for transmitting a plurality of light emission data signals, a plurality of light emission pixels defined by the scan and column lines, and an anode electrode for receiving an anode voltage. The scan signal is transmitted to the light emission pixels in response to a first scan-on voltage and a first scan-on-time and one of the first scan-on voltage and the first scan-on-time increases when the anode current flowing along the anode electrode is less than a first reference current.

### CROSS-REFERENCE TO RELATED APPLICATION

This application claims priority to and the benefit of Korean Patent Application No. 10-2007-0077724 filed in the Korean Intellectual Property Office on Aug. 2, 2007, the entire content of which is incorporated herein by reference.

### BACKGROUND OF THE INVENTION

1. Field of the Invention

The present invention relates to a display. More particularly, the present invention relates to a display having a light emission device that operates in response to a display image.

2. Description of the Related Art

A liquid crystal display (LCD) is a flat panel display configured to display an image by varying light transmittance of each pixel using the dielectric anisotropic properties of liquid crystal molecules, which varies the twisting angle of each of the molecules in accordance with an applied voltage. LCDs are lightweight and slim and operate with relatively low power consumption as compared with cathode ray tubes, which are typical image displays.

An LCD includes a liquid crystal panel assembly and a light emission device disposed in the rear of the liquid crystal panel assembly to emit light toward the liquid crystal panel assembly.

When the liquid crystal panel assembly is an active type, the liquid crystal panel assembly includes a pair of transparent substrates, a liquid crystal layer disposed between the transparent substrates, polarizing plates disposed on outer surfaces of the transparent substrates, a common electrode provided on an inner surface of one of the transparent substrates, pixel electrodes and switching devices provided on an inner surface of the other of the transparent substrates, and a color filter providing red, green, and blue colors to three sub-pixels forming one pixel.

The liquid crystal panel assembly receives light emitted from the light emission device and transmits or intercepts the light in accordance with the twisting angle of each of the liquid crystal molecules of the liquid crystal layer to realize a specified image.

The above information disclosed in this background section is presented only to enhance the understanding of the background of the invention and therefore may contain information that is not part of the prior art known to persons of ordinary skill in the art.

### SUMMARY OF THE INVENTION

In an exemplary embodiment of the present invention, a light emission device includes a plurality of scan lines for transmitting a plurality of scan signals, a plurality of column lines for transmitting a plurality of light emission data signals, a plurality of light emission pixels defined by the scan and column lines, and an anode electrode to which an anode voltage is applied. The scan signal is transmitted to the light emission pixels in response to a first scan-on voltage and a first scan-on-time, and one of the first scan-on voltage and the first scan-on-time increases when the anode current flowing along the anode electrode is less than a first reference current. When the anode current is less than the first reference current, the first scan-on-time may increase step by step. When the anode current is less than the first reference current, the first scan-on voltage may increase step by step. When the anode current is less than the first reference current, the first scan-on voltage may increase after the first scan-on-time increases by at least one time. When the anode current is less than the first reference current, even after the first scan-on-time increases to a maximum level, the first scan-on voltage may increase. At this point, when the anode current is less than the first reference current, even after the first scan-on voltage increases, and the first scan-on-time is set in response to the increased first scan-on voltage, the first scan-on-time may increase to compensate for the anode current.

In another exemplary embodiment of the present invention, a display includes a panel assembly including a plurality of gate lines for transmitting a plurality of gate signals, a plurality of data lines for transmitting a plurality of data signals, and a plurality of pixels defined by the gate and data lines. The display further includes a light emission device including a plurality of scan lines for transmitting a plurality of scan signals, a plurality of column lines for transmitting a plurality of light emission data signals, a plurality of light emission pixels defined by the scan and column lines, and an anode electrode to which an anode voltage is applied. The scan signal is transmitted to the light emission pixels in response to a first scan-on voltage and a first scan-on-time, and one of the first scan-on voltage and the first scan-on-time increases when the anode current flowing along the anode electrode is reduced due to a luminance non-uniformity of the light emission pixels, thereby compensating for the anode current. The anode current may be compensated for by increasing the first scan-on voltage after increasing the first scan-on-time. At this point, when the anode current is less than the first reference current, even after the first scan-on voltage increases and the first scan-on-time is set in response to the increased first scan-on voltage, the first scan-on-time may increase to compensate for the anode current.

In still another exemplary embodiment of the present invention, a method of driving a light emission device is provided. The light emission device includes a first electrode, a second electrode, a plurality of light emission pixels that emit light in response to a scan signal applied to a first electrode and a signal applied to a second electrode, and a third electrode along which a current corresponding to a current generated at the light emission pixels flows. The method of driving the light emission device includes applying a first scan-on voltage to the first electrode for a first scan-on-time, detecting the first current flowing along the third electrode, comparing the first current with a reference current, and increasing one of the first scan-on voltage and the first scan-on-time when the first current is less than the reference current. At this point, when the first current is less than the reference current, the first scan-on-time may increase. Alternatively, when the first current is less than the reference current, the first scan-on voltage may increase. Here, when the first current is less than the reference current, even after the first scan-on voltage increases and the first scan-on-time is set in response to the increased first scan-on voltage, the first scan-on-time may increase.

### BRIEF DESCRIPTION OF THE DRAWINGS

The above and other features and advantages of the present invention will be better understood with reference to the following detailed description when considered in conjunction with the attached drawings in which:

FIG. 1 is a partial cross-sectional view of a light emission device according to one exemplary embodiment of the present invention;

FIG. 2 is a partial cross-sectional view of a light emission device according to another exemplary embodiment of the present invention;

FIG. 3 is a partial exploded perspective view of an active area of the self-emissive light emission device of FIG. 2;

FIG. 4 is a block diagram of the light emission device of FIG. 1;

FIG. 5 is a block diagram of a light emission control unit of the light emission device of FIG. 4;

FIG. 6 is a flowchart illustrating a process for compensating for an anode current of the light emission device of FIG. 4;

FIG. 7 is a partial exploded perspective view illustrating an active area of a light emission device for a light source according to yet another embodiment of the present invention;

FIG. 8 is an exploded perspective view of a display, which uses the light emission device of FIG. 7 as a light source, according to an embodiment of the present invention; and

FIG. 9 is a block diagram of the display of FIG. 8.

### DETAILED DESCRIPTION

Light emission devices may be classified into a couple of different devices according to the type of light source used. Among the different devices, cold cathode fluorescent lamp (CCFL) types are well known. Since CCFLs are line light sources, a variety of optical members such as diffuser sheets, diffuser plates, and prism sheets are used to uniformly diffuse light emitted from the CCFL toward a liquid crystal panel assembly.

However, since the light emitted from a CCFL passes through the optical members, there may be significant light loss. In an LCD using a CCFL as the light source, an amount of light passing through the liquid crystal panel assembly is about 3-5% of the light emitted from the CCFL. Furthermore, the CCFL consumes a lot of power. That is, the power consumption of the CCFL takes the lion's share of the overall power consumption of the LCD. In addition, due to the structural limitations of the CCFL, large-sized LCDs using CCFLs cannot be made. Therefore, it is difficult to use CCFLs in LCDs over 30 inches.

In an effort to address these problems of CCFL type light emission devices, light emission diode (LED) type light emission devices have recently been proposed. A LED type light emission device has a plurality of LEDs that are point light sources, a reflecting sheet, a light guide plate, a diffuser sheet, a diffuser plate, and a prism sheet. LED type light emission devices have fast response speeds and excellent color reproducibility. However, LED type light emission devices are expensive and thick.

As described above, prior art light emission devices having different light sources have their own problems. Further, prior art light emission devices must be in an on-state with constant brightness when the LCD is driven, thereby making it difficult to improve the image quality required in the LCD.

For example, when the liquid crystal panel assembly displays an image having dark and bright portions (such as a video signal), dynamic contrast can be significantly improved if the light emission device emits light having different intensities to the dark and bright portions of the image.

In addition, in prior art light emission devices, the uniformity of the luminance may deteriorate as electron emission regions deteriorate. Therefore, in one embodiment of the present invention a light emission device increases the service life of electron emission regions and prevents non-uniformity of luminance by determining deterioration of the electron emission regions using an anode current and compensating for reduced anode current. In another embodiment of the present invention, a display uses the light emission device. In yet another embodiment, a method of driving the light emission device is provided. In still another embodiment, a method of driving the display is provided.

In the following detailed description, certain exemplary embodiments of the present invention are illustrated and described. As those skilled in the art would realize, the described embodiments may be modified in various different ways without departing from the spirit and scope of the present invention. Accordingly, the drawings and description are to be regarded as illustrative in nature and not restrictive. Like reference numerals designate like elements throughout the specification.

When a first member is connected to a second member, this means that the first member is directly or indirectly connected to the second member. That is, a third member may be interposed between the first and second members. Further, when it is described that a unit “includes” a constituent element, it means that the unit may further include other constituent elements in addition to the element unless specifically stated to the contrary.

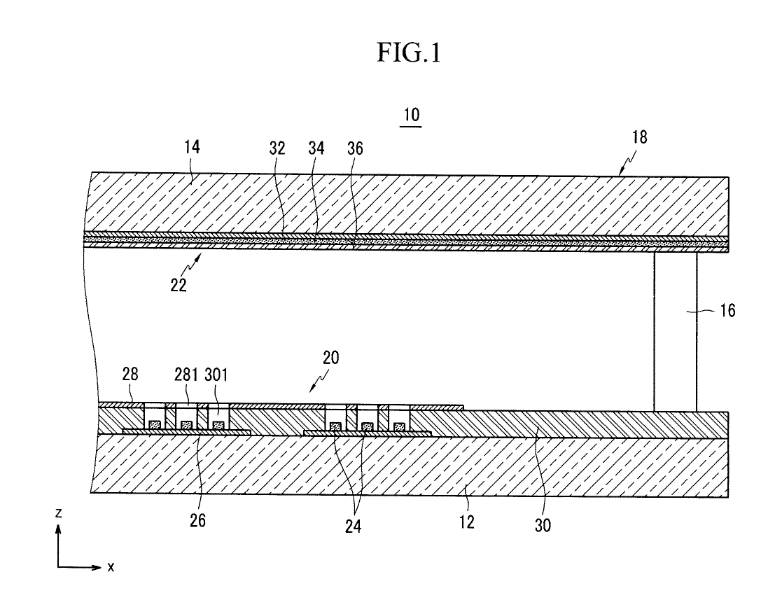

FIG. 1 is a partial cross-sectional view of a light emission device according to an exemplary embodiment of the present invention. Referring to FIG. 1, a light emission device 10 includes a vacuum vessel having a first substrate 12, a second substrate 14 and a sealing member 16 between the first and second substrates 12 and 14. The sealing member 16 is positioned along the edges of the first and second substrates 12 and 14 to seal the substrates together. The interior of the vacuum vessel is kept at a vacuum pressure of about 10⁻⁶ Torr.

The first and second substrates 12 and 14 may be divided into an active area (which is surrounded by the sealing member 16 and at which visible light is substantially emitted) and an inactive area surrounding the active area. An electron emission unit 20 for emitting electrons is located on an inner surface of the first substrate 12 at the active area, and a light emission unit 22 is located on an inner surface of the second substrate 14 at the active area.

The second substrate 14 on which the light emission unit 22 is located may be a front substrate of the light emission device 10, and the first substrate 12 on which the electron emission unit 20 is located may be a rear substrate of the light emission device 10.

The electron emission unit 20 includes electron emission regions 24, first driving electrodes 26 and second driving electrodes 28. The first and second driving electrodes 26 and 28 control the amount of electrons emitted from each of the electron emission regions 24. The first driving electrodes 26 may be cathode electrodes, and the second driving electrodes 28 may be gate electrodes intersecting the cathode electrodes 26. An insulation layer 30 is interposed between the first and second driving electrodes 26 and 28.

First openings 281 are formed in the gate electrodes 28 and second openings 301 are formed in the insulating layer 30. The first and second openings 281 and 301 are formed at intersecting regions of the cathode and gate electrodes 26 and 28, thereby partly exposing surfaces of the cathode electrodes 26.

The electron emission regions 24 are formed of a material that can emit electrons when an electric field is applied under a vacuum atmosphere. For example, the electron emission regions 24 may be formed of a carbon-based material or a nanometer-sized material. Nonlimiting examples of suitable materials for the electron emission regions 24 include carbon nanotubes, graphite, graphite nanofibers, diamond, diamond-like carbon, fullerene (C₆₀), silicon nanowires, and combinations thereof.

Alternatively, the electron emission regions may be formed into structures having sharp tips with a material such as molybdenum (Mo) or silicon (Si).

In the above-described structure, one intersecting region of the cathode and gate electrodes 26 and 28 may correspond to one pixel area of the light emission device 10. Alternatively, two or more intersecting regions of the cathode and gate electrodes 26 and 28 may correspond to one pixel area of the light emission device 10.

Next, the light emission unit 22 further includes an anode electrode 32, a phosphor layer 34 formed on a surface of the anode electrode 32, and a metal reflective layer 36 covering the phosphor layer 34. The anode electrode 32 is applied with an anode voltage from a power source disposed at an external side of the vacuum vessel 18 to maintain the phosphor layer 34 in a high potential state. The anode electrode 32 is formed of a transparent conductive material such as indium tin oxide (ITO) to allow the visible light emitted from the phosphor layer 34 to pass therethrough.

The metal reflective layer 36 may be formed of aluminum, has a thickness of thousands of Å, and has finely sized holes through which the electron beams pass. The metal reflective layer 36 reflects the visible light (which is emitted from the phosphor layer 34 to the first substrate 12) toward the second substrate 14 to enhance the luminance of the light emission surface. However, the anode electrode 32 may be eliminated and the metal reflective layer 36 may be configured to function as the anode electrode to which the anode voltage is applied.

A plurality of spacers (not shown) are located at the active area between the first and second substrates 12 and 14 to resist compression forces applied to the vacuum vessel 18, and to uniformly maintain a gap between the first and second substrates 12 and 14.

The above-described light emission device 10 is driven by applying a driving voltage to the cathode and gate electrodes 26 and 28 and applying thousands or more volts of a positive direct voltage (anode voltage) to the anode electrode 32. That is, a scan driving voltage is applied to one of the cathode and gate electrodes 26 and 28, and a data driving voltage is applied to the other of the cathode and gate electrodes 26 and 28.

Then, an electric field is formed around the electron emission regions 24 at pixels where a voltage difference between the cathode and gate electrodes 26 and 28 is higher than a threshold value, and thus electrons are emitted from the electron emission regions 24. The electrons emitted from the electron emission regions 24 are attracted by the anode voltage and collide with the phosphor layer 34. The light emission intensity of the phosphor layer 34 by each pixel is proportional to the amount of electron beams of the corresponding pixel.

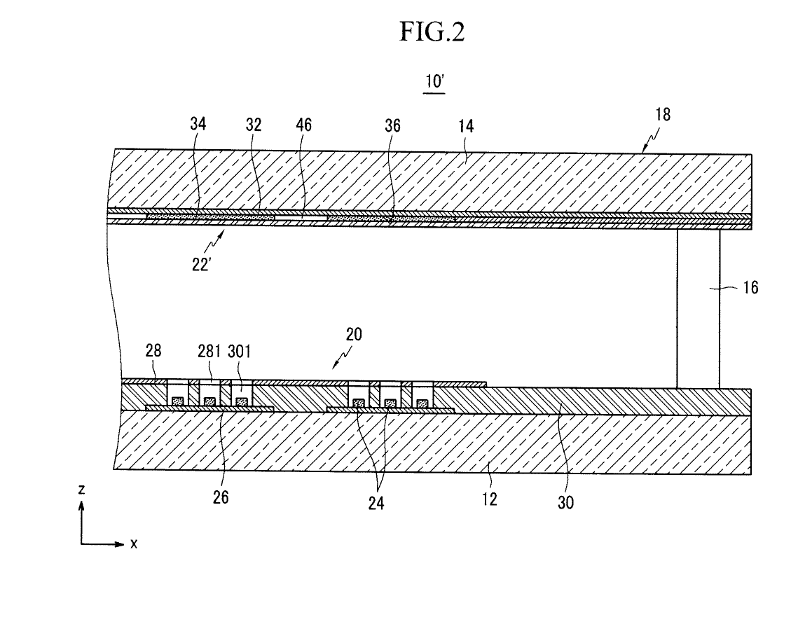

FIG. 2 is a partial cross-sectional view of a light emission device according to another exemplary embodiment of the present invention. Referring to FIG. 2, a light emission device 10′ is identical to the light emission device 10 of the previous embodiment, except that the light emission unit 22′ further includes a dark colored or black layer 46. In this and the previous exemplary embodiments, like reference numerals designate like elements.

In the current embodiment, the phosphor layer 34 is divided into a plurality of spaced apart sections and the black layer 46 is formed between the sections of the phosphor layer 34. The dark colored or black layer 46 may be formed of chromium. In the present exemplary embodiment, the anode electrode 32 may be omitted, and the metal reflective layer 36 may function as the anode electrode to which the anode voltage is applied.

The light emission devices 10 and 10′ may be used as light sources for emitting white light to a passive-type display panel (non-emissive type display panel) or may be used as a display itself by forming red, green, and blue phosphor layers.

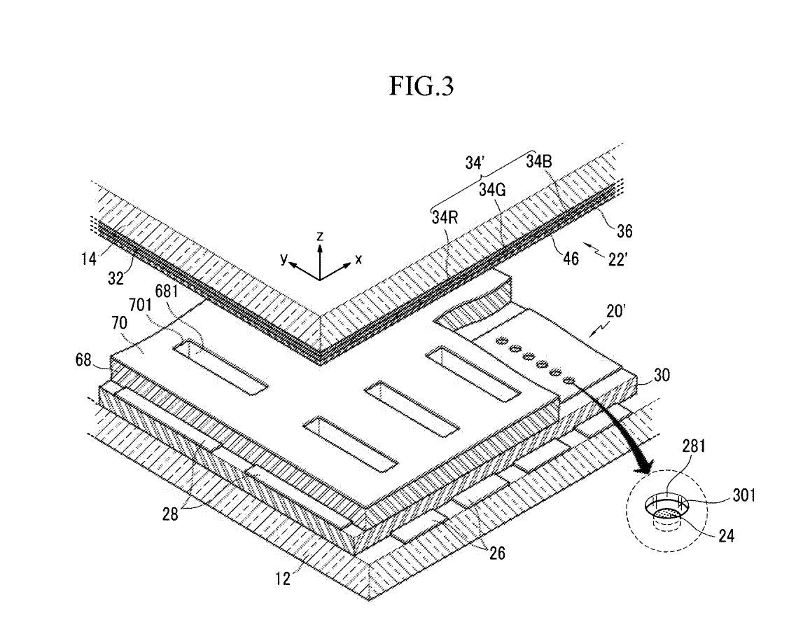

FIG. 3 is an exploded perspective view of an active area of the self-emissive light emission device of FIG. 2. Referring to FIG. 3, in the self-emissive light emission device, the electron emission unit 20′ includes cathode electrodes 26, gate electrodes 28, and electron emission regions 24 electrically connected to the cathode electrodes 26. A first insulation layer 30 is disposed between the cathode electrodes 26 and the gate electrodes 28, and a second insulation layer 68 is formed on the gate electrodes 28. A focusing electrode 70 is formed on the second insulation layer 68.

First openings 681 and second openings 701 are respectively formed in the second insulation layer 68 and the focusing electrode 70 to allow electron beams to pass therethrough. A negative direct voltage of 0V or several to tens of volts is applied to the focusing electrode 70 to converge the electrons passing through the second openings 701 formed in the focusing electrode 70.

The light emission unit 22′ includes an anode electrode 32, phosphor layers 34′ formed on a surface of the anode electrode 32 including red, green, and blue phosphor layers 34R, 34G, and 34B spaced apart from each other, a dark colored layer 46 formed between the phosphor layers 34′, and a metal reflective layer 36 covering the phosphor layers 34′ and the dark colored layer 46.

One intersecting region of the cathode and gate electrodes 26 and 28 may correspond to one subpixel and each of the red, green, and blue phosphor layers 34R, 34G, and 34B are positioned to correspond to one subpixel. Three subpixels including one red phosphor layer 34R, one green phosphor layer 34G, and one blue phosphor layer 34B located in a line form one pixel.

The amount of electrons emitted from each of the electron emission regions 24 of the respective subpixels are determined by the driving voltage applied to the cathode and gate electrodes 26 and 28. The electrons collide with the phosphor layer 34′ of the corresponding subpixel, thereby exciting the phosphor layer 34′. By the above-described process, the light emission device controls the luminance and light emission color of each pixel, thereby realizing a color image.

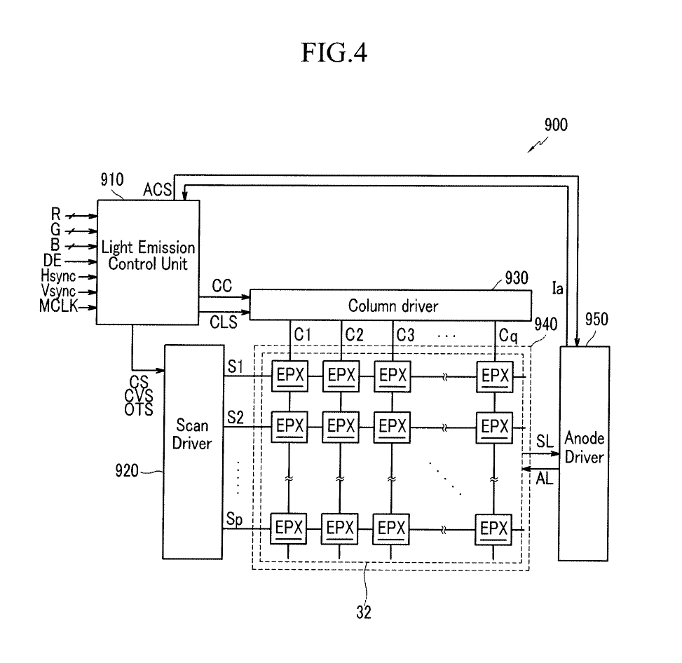

A light emission device according to the current exemplary embodiment and a method of driving the light emission device will now be described with reference to FIG. 4. FIG. 4 is a block diagram of the light emission device according to the current exemplary embodiment of the present invention. As shown in FIG. 4, the light emission device 900 includes an anode electrode 32, a light emission control unit 910, a scan driver 920, a column driver 930, a light emission unit 940, and an anode driver 950.

In the current exemplary embodiment of the present invention, scan lines S1-Sp function as the gate electrodes 28 of light emission pixels EPX, and column lines C1-Cq function as the cathode electrodes 26 of the light emission pixels EPX and are connected to the electron emission regions 24.

Input video signals R, G, and B have luminance information of each light emission pixel EPX. The luminance has a grayscale of, for example, 1024 (or 2¹⁰), 256 (or 2⁸), or 64 (or 2⁶). A vertical synchronization signal Vsync, a horizontal synchronization signal Hsync, a main clock MCLK, and a data enable signal DE may be provided as input control signals.

The anode electrodes 32 are included in the front substrate of the light emission device 900 and connected to the anode line AL and the sensing line SL. An anode voltage is applied to the anode electrode 32 in accordance with an anode control signal ACS transmitted to the anode driver 950. At this point, the anode voltage is applied to the anode electrode 32 through the anode line AL. The anode voltage is a relatively high voltage for attractively accelerating the emitted electron beams. When the electrons are emitted by a difference of the voltages applied to the cathode and gate electrodes 26 and 28, an anode current Ia is generated on the anode electrode 32 by the electrons attracted by the high voltage applied to the anode electrode 32. In the light emission device of the present exemplary embodiment, the anode current Ia is generated to correspond to the electrons emitted by the voltages applied to the cathode and gate electrodes 28.

The scan driver 920 is connected to the scan lines S1-Sp to transmit a plurality of scan signals to the scan lines S1-Sp, thereby allowing the light emission pixels EPX to emit light in response to a scan driving control signal CS, a scan voltage control signal CVS, and an on-time control signal OTS.

The column driver 930 is connected to the column lines C1-Cq to allow the light emission pixels EPX to emit the light in response to a light emission control signal CC and a light emission signal CLS. In more detail, the column driver 930 generates a plurality of light emission data signals in response to the light emission signal CLS and transmits the light emission data signals to the column lines C1-Cq in response to the light emission control signal CC. In the light emission device of the present exemplary embodiment of the present invention, the light emission data signal has a voltage level corresponding to a specified grayscale matching with the image that is being displayed.

The light emission unit 940 includes a plurality of scan lines S1-Sp transmitting the scan signal, a plurality of column lines C1-Cq, and a plurality of light emission pixels EPX. The light emission pixels EPX are located on intersecting regions of the scan lines S1-Sp and the column lines C1-Cq. At this point, the scan lines S1-Sp are connected to the scan driver 920 and the column lines C1-Cq are connected to the column driver 930. The scan and column drivers 920 and 930 are connected to the light emission control unit 910 to operate in response to the control signal from the light emission control unit 910.

The anode driver 950 receives the anode control signal ACS from the light emission control unit 910 and applies the anode voltage to the anode electrode 32 in response to the anode control signal ACS. Further, the anode driver 950 detects (through a sensing line SL) the anode current generated by the electrons emitted by the voltage difference between the cathode and gate electrodes 26 and 28. The anode driver 950 transmits the anode current Ia to the light emission control unit 910. In the current exemplary embodiment of the present invention, the detecting of the anode current Ia is realized by a user-specified period unit.

The light emission control unit 910 controls the scan driver 920, the column driver 930, and the anode driver 950. The light emission control unit 910 receives the input video signal R, G, and B and input control signal for controlling the display of the image from an external graphic controller (not shown).

The light emission control unit 910 properly processes the input video signals R, G, and B in response to the input control signal so that the input video signal R, G, and B can match the operational conditions of the light emission unit 940, thereby generating the scan driving control signal CS, scan voltage control signal CVS, on-time control signal OTS, light emission control signal CC, and light emission signal CLS.

The light emission control unit 910 detects the grayscales of the light emission pixels EPX using the input video signals R, G, and B, converts the grayscales into digital data, and transmits the digital data to the column driver 930. At this point, the digital data is contained in the light emission signal CLS. The light emission control unit 910 generates the light emission control signal CC to control the application timing of the light emission data signals in response to the light emission signal CLS.

The light emission control unit 910 determines the deterioration of the electron emission regions 24 in accordance with the anode current Ia, generates the scan voltage control signal CVS and the on-time control signal OTS to prevent the luminance non-uniformity caused by the deterioration of the electron emission regions 24, and transmits the CVS and OTS signals to the scan driver 920. Further, the light emission control unit 910 generates the scan driving control signal CS for controlling the timing of transmission of the scan signal to the scan lines S1-Sp and transmits the scan driving control signal CS to the scan driver 920. At this point, the scan signal has a scan-on voltage Von having a voltage level that can emit the electrons from the electron emission regions 24, and a scan-off voltage having a voltage that prevents the electrons from being emitted from the electron emission regions 24. In the current exemplary embodiment of the present invention, the level of the scan-on voltage Von is determined in accordance with the scan voltage control signal CVS transmitted from the scan driver 920. The scan-on voltage is transmitted to the scan lines S1-Sp in accordance with the scan driving control signal CS. In addition, the timing for transmission of the scan-on voltage Von is determined in accordance with the on-time control signal OTS. Here, the scan-on voltage Von is set within a range where substantially no luminance non-uniformity occurs in the light emission device 900. At this point, the lowest voltage level of the scan-on voltage Von is a minimum scan-on voltage Von_min, and the highest voltage level of the scan-on voltage Von is a maximum scan-on voltage Von_max. That is, the light emission control unit 910 sets a range where luminance non-uniformity is allowable (hereinafter, referred to as “luminance non-uniformity allowable range”). A voltage that corresponds to maximum luminance non-uniformity is set as the minimum scan-on voltage (Von_min) within the luminance non-uniformity allowable range. The light emission control unit 910 sets the maximum voltage that is allowable in the structure of the scan driver 920, sets the light emission value of the light emission device that is allowable when a grayscale is lowest, and sets the maximum scan-on voltage Von_max considering the supply voltage limitation of the power source.

In more detail, the light emission control unit 910 sets a scan-on-time for which the scan-on voltage Von is applied to the scan lines S1-Sp in response to the scan-on-time control signal OTS. In the current exemplary embodiment of the present invention, the scan-on-time may be set in accordance with the scan-on voltage Von. The scan-on-time increases by a specified period when the luminance uniformity occurs for a period for which the scan-on voltage Von is uniformly maintained. The light emission control unit 910 detects the anode current Ia generated by the electrons emitted from the electron emission regions 24 to determine if the electron emission regions 24 are deteriorated. At this point, when luminance non-uniformity occurs due to the deterioration of the electron emission regions 24, the light emission control unit 910 increases the scan-on-time to solve the luminance non-uniformity problem. However, when the luminance non-uniformity problem is not solved even after the scan-on-time increases to a maximum level, the light emission controller gradually increases the scan-on voltage Von in response to the scan voltage control signal CVS to solve the luminance non-uniformity problem. That is, when the luminance non-uniformity occurs while the scan-on-time is at maximum level, the light emission control unit 910 increases the level of the scan-on voltage Von. In the current exemplary embodiment of the present invention, the level of the scan-on voltage Von is set in accordance with the amount of anode current and may increase step by step up to the maximum scan-on voltage Von_max which can be obtained right before an abnormal phenomenon (such as short circuit) occurs, considering peripheral driving elements. At this point, the scan voltage control signal CVS controls the scan driver 920 such that the scan signal having the specified scan-on voltage Von can be output. That is, the scan driver 920 selects one of the scan-on voltages in accordance with the scan voltage control signal CVS and outputs the selected voltage as the scan signal.

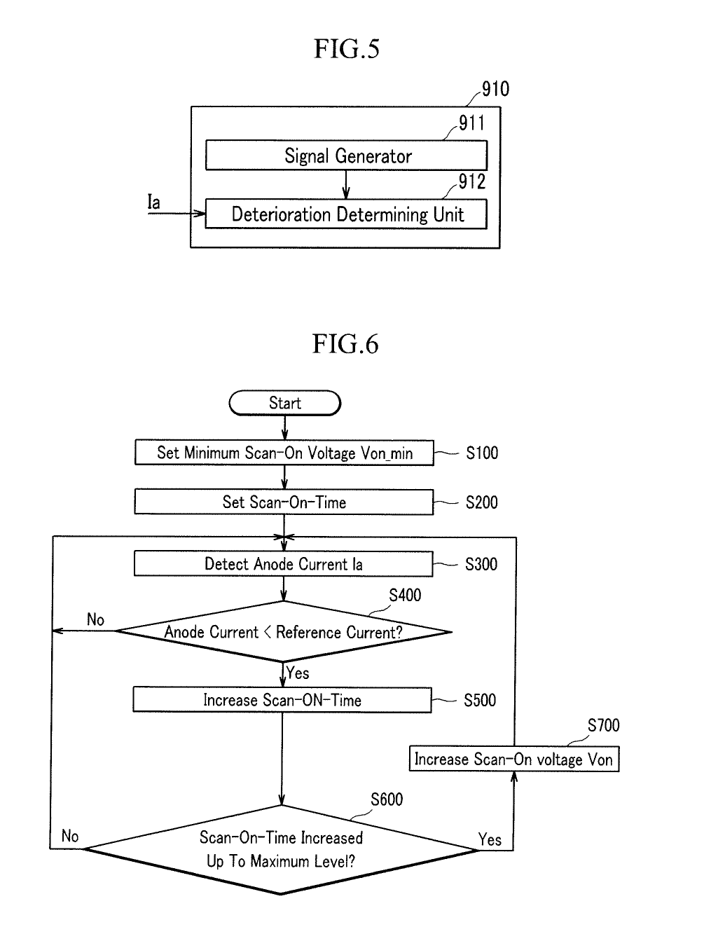

A method for compensating for reductions in the anode current Ia due to the deterioration of the electron emission regions 24 will now be described with reference to FIGS. 5 and 6. FIG. 5 is a block diagram illustrating the light emission control unit 910 of the light emission device of FIG. 4. As shown in FIG. 5, the light emission control unit includes a signal generator 911 and a deterioration determining unit 912.

The signal generator 911 generates the scan voltage control signal CVS and transmits the generated signal to the scan driver 920 to set the scan-on voltage Von applied to the scan lines S1-Sp. Further, the signal generator 911 generates the on-time control signal OTS and transmits the on-time control signal to the scan driver 920 to set the scan on-time for which the scan-on voltage Von is applied to the scan lines S1-Sp. At this point, the scan driver 920 generates the scan-on voltage Von in response to the scan voltage control signal CVS and sets the scan-on-time corresponding to the scan-on voltage Von in response to the on-time control signal OTS.

The deterioration determining unit 912 detects the anode current Ia that is generated from the voltage difference between the minimum scan-on voltage Von_min applied to the scan lines S1-Sp and the voltage applied to the cathode electrodes 26 for the scan-on time set in response to the minimum scan-on voltage Von_min among the scan-on voltages Von. The deterioration determining unit 912 determines if the electron emission regions 24 are deteriorated by comparing the anode current Ia with a reference current. In this exemplary embodiment of the present invention, the reference current is a current that is generated from the voltage difference between the scan-on voltage Von applied to the scan lines S1-Sp and the voltage applied to the cathode electrodes 26. That is, the reference current is a reference value for determining the deterioration. At this point, when the anode current Ia is less than the reference current, the deterioration determining unit 912 determines that the anode current Ia is reduced due to the deterioration and increases the scan-on-time by a period within a range in which the minimum scan-on voltage Von_min is maintained, thereby compensating for the reduced anode current Ia. That is, the time for which the minimum scan-on voltage Von-min is applied to the scan lines S1-Sp is proportional to the increase of the scan-on-time. Therefore, the amount of electrons emitted from the electron emission regions increases to compensate for the reduced anode current Ia. However, when the anode current Ia is not compensated for even after the scan-on-time increases to the maximum level, the deterioration determining unit 912 applies a higher than the minimum scan-on voltage Von_min to the scan lines S1-Sp. That is, by increasing the level of the scan-on voltage Von, a voltage difference between the increased scan-on voltage Von and the voltage applied to cathode electrodes 26 increases and thus the amount of electrons emitted from the electron emission regions increases, thereby compensating for the reduced anode current Ia. At this point, the deterioration determining unit 912 controls the scan-on voltage Von such that the level of the scan-on voltage Von does not increase above the maximum scan-on voltage Von_max. The deterioration determining unit 912 detects the anode current Ia generated in response to the increased scan-on voltage Von and compares the generated anode current Ia with the reference current. Here, when the anode current Ia is less than the reference current and thus cannot compensate for the reduced anode current Ia, the deterioration determining unit 912 repeats the process for increasing the scan-on-time and the scan-on voltage Von until the reduced anode current Ia is compensated for.

FIG. 6 is a flowchart illustrating the process for compensating for the anode current Ia of the light emission device of this exemplary embodiment. First, the light emission control unit 910 sets the minimum scan-on voltage Von_min in response to the scan voltage control signal CVS (S100). Further, the light emission control unit 910 sets the scan-on-time corresponding to the minimum scan-on voltage Von_min in response to the on-time control signal OTS (S200). The light emission control unit 910 detects the anode current Ia that is generated from the voltage difference between the minimum scan-on voltage Von_min applied to the scan lines S1-Sp and the voltage applied to the cathode electrodes 26 for the scan-on time which is set in response to the minimum scan-on voltage Von_min among the scan-on voltages Von (S300). In addition, the light emission control unit 910 compares the anode current with the reference current (S400).

When the anode current Ia is less than the reference current, the light emission control unit 910 increases the scan-on-time while maintaining the minimum scan-on voltage Von_min (S500). Further, the light emission control unit 910 determines if the scan-on-time increases to the maximum level while maintaining the minimum scan-on voltage Von_min (S600).

When it is determined that the scan-on-time has not increased to the maximum level, the light emission control unit 910 detects the anode current Ia generated in accordance with the scan-on-time increase. When the anode current Ia detected is reduced due to the deterioration of the electron emission regions, the light emission control unit 910 repeats the process for gradually increasing the scan-on-time to compensate for the anode current Ia. When the anode current Ia is not compensated for even after the scan-on-time reaches the maximum set value, the light emission control unit 910 increases the scan-on voltage Von (S700). At this point, the maximum set value means a maximum value up to which the scan-on-time may increase. The maximum set value may be set by the user.

When the anode current Ia is less than the reference current even after the increased scan-on-voltage Von (increased in Step S700) is applied to the scan lines S1-Sp, the light emission control unit 910 repeats the same process until the reduced anode current Ia is compensated for to solve the luminance non-uniformity phenomenon.

In the present exemplary embodiment of the present invention, in order to compensate for the reduced anode current Ia, the scan-on-time is first increased, after which the scan-on voltage is increased. However, the present invention is not limited to this embodiment. That is, the scan-on voltage Von may first be increased, after which the scan-on-time may be increased to compensate for the reduced anode current Ia.

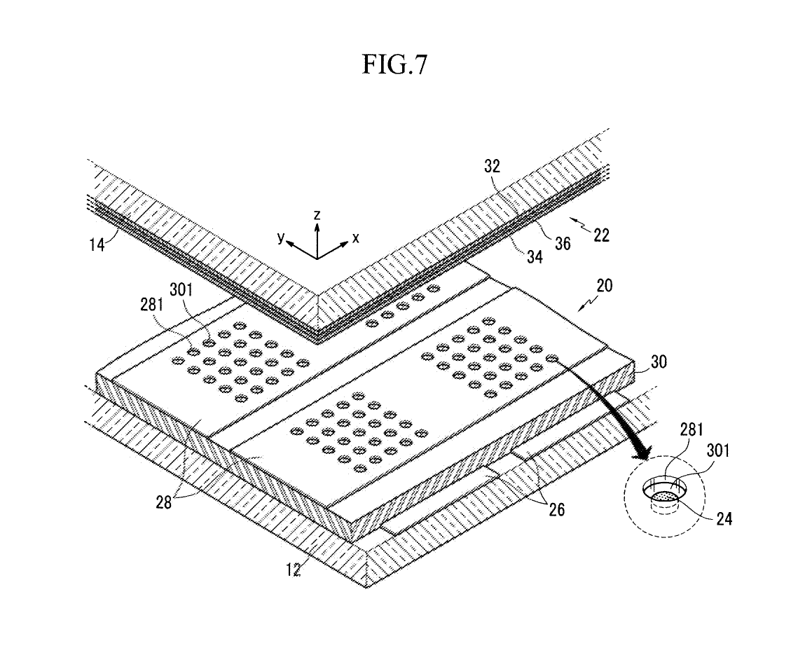

FIG. 7 is a partial exploded perspective view of an active area of a light emission device according to another exemplary embodiment of the present invention. Referring to FIG. 7, in a light emission device used as a light source, an electron emission unit 20 includes cathode electrodes 26, gate electrodes 28, and electron emission regions 24 electrically connected to the cathode electrodes 26. The light emission unit 22 includes an anode electrode 32, a phosphor layer 34 for emitting white light, and a metal reflective layer 36 covering the phosphor layer 34.

The phosphor layer 34 may be formed of a mixture of red, green, and blue phosphors. The phosphor layer 34 may be formed on an entire active area of the second substrate 14.

In the light emission device for the light source, the first and second substrates 12 and 14 are spaced apart from each other by about 5 to about 20 mm. As the gap between the first and second substrates 12 and 14 increases, a relatively high voltage of more than about 10 kV, for example, from about 10 to about 15 kV can be applied to the anode electrode 32. The light emission device structured as described above can realize a maximum luminance of about 10,000 cd/m2.

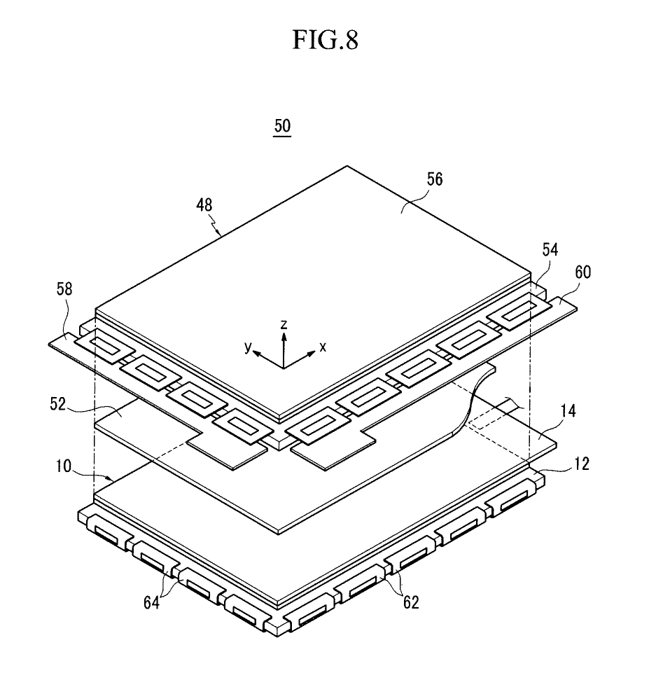

FIG. 8 is an exploded perspective view of a display employing the light emission device of FIG. 7 according to an embodiment of the present invention. Referring to FIG. 8, a display 50 includes a light emission device 10 and a display panel 48 located in front of the light emission device 10. A diffuser plate 52 may be located between the light emission device 10 and the display panel 48 to evenly diffuse the light emitted from the light emission device 10. The diffuser plate 52 is spaced apart from the light emission device 10.

The display panel 48 may be a liquid crystal panel or other passive type display panel. A liquid crystal display will now be described by way of example.

The display panel 48 includes a lower substrate 54 on which a plurality of thin film transistors (TFTs) are formed, an upper substrate 56 on which a color filter is formed, and a liquid crystal layer (not shown) disposed between the lower and upper substrates 54 and 56. Diffuser plates (not shown) are adhered to the top surface of the upper substrate 56 and the bottom surface of the lower substrate 54 to polarize the light passing through the display panel 48.

Transparent pixel electrodes that are controlled by the TFTs for the respective subpixels are located on the inner surface of the lower substrate 54, and a color filter and a transparent common electrode are located on the inner surface of the upper substrate 56. The color filter includes red, green, and blue filter layers that are located one by one on the subpixels.

When the TFT of one specific subpixel is turned on, an electric field is formed between the pixel electrodes and the common electrode, and the twisting angles of liquid crystal molecules vary according to the electric field. Light transmission varies according to the varied twisting angles. The display panel 48 can control the luminance and light emission color of each pixel through the above-described process.

In FIG. 8, reference numeral 58 indicates a gate circuit board assembly which transmits a gate driving signal to the gate electrodes 28 of each TFT, and reference numeral 60 indicates a data circuit board assembly which transmits a data driving signal to the source electrode of each TFT.

The number of pixels of the light emission device 10 is less than the number of pixels of the display panel 48 so that one pixel of the light emission device 10 corresponds to two or more pixels of the display panel 48. Each of the pixels of the light emission device 10 emits light in response to the highest grayscale of the corresponding pixel of the display panel 48, which has the highest grayscale. Each of the pixels of the light emission device 10 represents a grayscale of 2-8 bits.

For convenience, the pixels of the display panel 48 will be referred to as “first pixels” and the pixels of the light emission device will be referred to as “second pixels.” First pixels corresponding to one second pixel will be referred to as a “first pixel group.”

A driving process of the light emission device 10 may include (a) detecting the highest grayscale of the first pixels of the first pixel group using a signal control unit (not shown) controlling the display panel 48, (b) calculating the grayscale required for exciting the second pixels from the detected highest grayscale and converting the calculated grayscale into digital data, (c) generating a driving signal of the light emission device 10 using the digital data, and (d) applying the generated driving signal to the light emission device 10.

Scan and data circuit board assemblies for driving the light emission device 10 may be disposed on the rear surface of the light emission device 10. In FIG. 8, reference numeral 62 indicates a connector for connecting the cathode electrodes 26 to the data circuit board assembly, and reference numeral 64 denotes a connector for connecting the gate electrodes 28 to the scan circuit board assembly.

As described above, the second pixel of the light emission device 10 emits light with a particular grayscale by synchronizing with the corresponding first pixel group when the corresponding first pixel group displays an image. That is, the light emission device 10 emits light having high luminance to a bright portion of the image displayed by the display panel 48 and emits light having low luminance to a dark portion of the image. Accordingly, the display 50 can provide improved dynamic contrast and image quality.

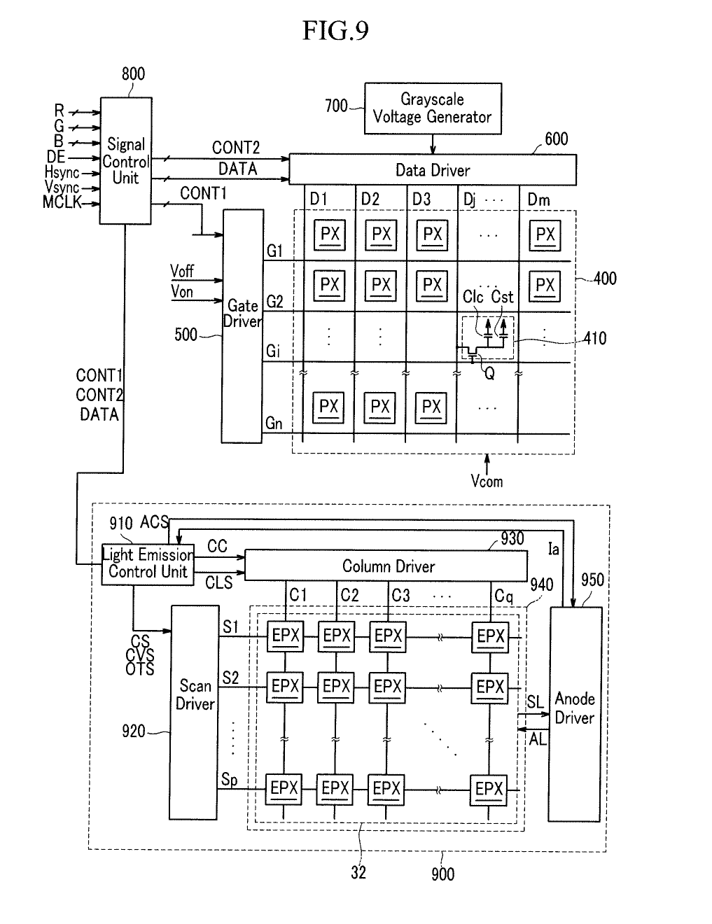

A display and a method of driving the display will now be described with reference to FIG. 9. FIG. 9 is a block diagram of the display of FIG. 8. The display of this exemplary embodiment of the present invention is a passive type device and includes a liquid crystal panel assembly 400. However, the present invention is not limited thereto.

As shown in FIG. 9, the display 50 of this exemplary embodiment of the present invention includes a liquid crystal panel assembly 400, gate and data drivers 500 and 600 connected to the liquid panel assembly 400, a grayscale voltage generator 700 connected to the data driver 600, and a signal control unit 800 for controlling the light emission device 900.

When the liquid crystal panel assembly 400 is regarded as an equivalent circuit, the liquid crystal panel assembly 400 includes a plurality of signal lines, and a plurality of pixels PX arranged in a matrix pattern and connected to the signal lines. The signal lines include a plurality of gate signal lines G1-Gn which transmit a gate signal (scan signal) and a plurality of data lines D1-Dm which transmit a data signal.

Each pixel PX, for example, a pixel 410 connected to the iₜₕ (i=1, 2, . . . n) gate line Gi and the jₜₕ (j=1, 2, . . . m) data line Dj includes a switch Q connected to the signal lines Gi and Dj, and a liquid crystal capacitor Clc and a sustain capacitor Cst are connected to the switch Q. The sustain capacitor Cst may be omitted if necessary.

The switch Q is a 3-terminal device (such as a TFT) provided on the lower substrate (not shown). That is, the switch Q includes a control terminal connected to the gate line Gi, an input terminal connected to the data line Dj, and an output terminal connected to the liquid crystal capacitor Clc and sustain capacitor Cst.

The gate driver 500 is connected to the gate lines G1-Gn for applying a gate signal (which is a combination of a gate-on voltage Von and a gate-off voltage Voff) to the gate lines G1-Gn.

The data driver 600 is connected to the liquid crystal panel assembly 400 and the data lines D1-Dm. The data driver 600 selects a grayscale voltage from the grayscale voltage generator 700 and applies the same to the data lines D1-Dm as the data signal. However, when the grayscale voltage generator 700 is not designed to provide all of the voltages for all the grayscales, but only some of the voltages for the grayscales, the data driver 600 divides a reference grayscale voltage, generates grayscale voltages for all of the grayscales, and selects the data signal from the generated grayscale voltages.

The grayscale voltage generator 700 generates two sets of grayscale voltage groups (or reference grayscale voltage groups) related to the transmission of the pixels PX. One of the two sets has a positive value with respect to the common voltage Vcom and the other has a negative value.

The signal control unit 800 controls the gate driver 500, the data driver 600, and the light emission control unit 910. The signal control unit 800 receives video signals R, G, and B from the external graphic controller (not shown) and input control signals for controlling the display.

The input video signals R, G, and B have luminance information of the pixels PX. The luminance has a number of grayscales, for example, 1024 (or 2¹⁰), 256 (or 2⁸) or 64 (or 2⁶). The input control signals include, for example, a vertical synchronization signal Vsync, a horizontal synchronization signal Hsync, a main clock MCLK, and a data enable signal DE.

The signal control unit 800 properly processes the input video signals R, G, and B based on the input control signals, generates the gate control signal CONT1 and the data control signal CONT2, outputs the gate control signal CONT1 to the gate driver 500, and outputs the processed video signal DATA and the data control signal CONT2 to the data driver 600. In addition, the signal control unit 800 transmits the gate control signal CONT1, data control signal CONT2, and processed video signal DATA to the light emission control unit 910.

In this exemplary embodiment of the present invention, the light emission device for the light source (hereinafter, referred to as “light emission device”) 900 includes the light emission control unit 910, the scan driver 920, the column driver 930, and the light emission unit 940.

As shown in FIG. 9, the scan lines S1-Sp function as the gate electrodes 28 of the light emission pixels EPX and the column lines C1-Cq function as the cathode electrodes 26 of the light emission pixels EPX. The column lines C1-C1 are connected to the electron emission regions 24.

The anode electrode 32 is included in the front substrate of the light emission device 900 and connected to the anode line AL and the sensing line SL. The anode electrode 32 receives the anode voltage in accordance with the anode control signal SCS transmitted to the anode driver 950. At this point, the anode voltage is applied to the anode electrode 32 through the anode line AL. The anode voltage is a relatively high voltage for attracting the emitted electron beams. Further, when the electrons are emitted by a voltage difference between the cathode and gate electrodes 26 and 28, the anode current Ia is generated on the anode electrode 32 by the electrons attracted by the high voltage. In this exemplary embodiment of the present invention, the anode current Ia is generated in response to the amount of electrons emitted in accordance with the voltage applied to the cathode and gate electrodes 26 and 28.

The scan driver 920 is connected to the scan lines S1-Sp to transmit the scan signals so that the light emission pixels EPX can emit light by synchronizing with the corresponding pixels PX in accordance with the scan driving control signal CS, the scan voltage control signal CVS, and the on-time control signal OTS.

The column driver 930 is connected to the column lines C1-Cq to control the column lines C1-Cq so that the light emission pixels EPX can emit light in response to the grayscale of the corresponding pixels PX in accordance with the light emission control signal CC and the light emission signal CLS. In more detail, the column driver 930 generates light emission data signals in response to the light emission signal CLS and transmits the generated light emission data signals to the column lines C1-Cq in accordance with the light emission control signal CC. That is, the column driver 930 synchronizes one light emission pixel EPX to emit light with a specified grayscale in response to the image displayed by the corresponding pixels PX. In this exemplary embodiment of the present invention, the light emission data signals have a voltage level corresponding to the specified grayscale that is set in response to the image being displayed.

The light emission unit 940 includes the scan lines S1-Sp transmitting the scan signal, the column lines C1-Cq transmitting the light emission data signal, and the light emission pixels EPX. The light emission pixels EPX are located at intersecting areas of the scan lines S1-Sp and the column lines C1-Cq. At this point, the scan lines S1-Sp are connected to the scan driver 920 and the column lines C1-Cq are connected to the column driver 930. Further, the scan driver 920 and the column driver 930 are connected to the light emission control unit 910 to operate responsive to the signal from the light emission control unit 910.

The anode driver 950 receives the anode control signal ACS from the light emission control unit 910 and applies the anode voltage to the anode electrode 32 in accordance with the anode control signal ACS. Further, the anode current Ia is generated by the electrons generated by the voltage difference between the cathode and gate electrodes 26 and 28, and the anode driver 950 detects the anode current Ia using the sensing line SL. The anode driver 950 transmits the anode current Ia to the light emission control unit 910. In this exemplary embodiment of the present invention, the detecting of the anode current Ia is realized by a period that can be set by the user.

The light emission control unit 910 controls the scan driver 920, the column driver 930, and the anode driver 950. The light emission control unit 910 receives the input video signals R, G, and B from the external graphic controller (not shown) and receives an input control signal for controlling the display of the input video signals R, G, and B.

The light emission control unit 910 receives the gate control signal CONT1, the data control signal CONT2, and the processed video signal DATA from the signal control unit 800. The light emission control unit 910 detects the highest grayscale of the pixels PX corresponding to one light emission pixel EPX of the light emission device using the video signal DATA and determines the grayscale of the light emission pixel in response to the detected highest grayscale. The light emission control unit 910 converts the grayscale into digital data and transmits the digital data to the column driver 930. At this point, the digital data is included in the light emission signal CLS. The light emission control unit 910 generates the light emission control signal CC to control the application timing of the light emission data signals in accordance with the light emission signal CLS and transmits the generated light emission control signal CC to the column driver 930.

The light emission control unit 910 determines (through the anode current Ia) if the electron emission regions 24 are deteriorated. In addition, the light emission control unit 910 generates the scan voltage control signal CVS and the on-time control signal OTS and transmits the same to the scan driver 920 to prevent luminance non-uniformity caused by the deterioration of the electron emission regions 24. Further, the light emission control unit 910 generates the scan driving control signal CS controlling the transmission timing of the scan signal to the scan lines S1-Sp using the gate control signal CONT1, and transmits the generated scan driving control signal CS to the scan driver 920. At this point, the scan signal has a scan-on voltage Von having a voltage level that can emit electrons from the electron emission regions 24, and a scan-off voltage having a voltage that prevents electrons from being emitted from the electron emission regions 24. In the present exemplary embodiment of the present invention, the level of the scan-on voltage Von is determined according to the scan voltage control signal CVS transmitted from the scan driver 920. The scan-on voltage is transmitted to the scan lines S1-Sp according to the scan driving control signal CS. In addition, the timing for transmitting the scan-on voltage Von is determined according to the on-time control signal OTS. Here, the scan-on voltage Von is set within a range where substantially no luminance non-uniformity of the light emission device 900 occurs. The lowest voltage level of the scan-on voltage Von is a minimum scan-on voltage Von_min, and the highest voltage level of the scan-on voltage Von is a maximum scan-on voltage Von_max. That is, the light emission control unit 910 sets a range where luminance non-uniformity is allowable (hereinafter referred to as “luminance non-uniformity allowable range”). A voltage that corresponds to maximum luminance non-uniformity is set as the minimum scan-on voltage (Von_min) within the luminance non-uniformity allowable range. The light emission control unit 910 sets a maximum voltage that is allowable in the structure of the scan driver 920, sets a light emission value of the light emission device that is allowable when a grayscale is lowest, and sets a maximum scan-on voltage Von_max considering the supply voltage limitation of the power source.

In more detail, the light emission control unit 910 sets a scan-on-time for which the scan-on voltage Von is applied to the scan lines S1-Sp in response to the scan-on-time control signal OTS. In the present exemplary embodiment of the present invention, the scan-on-time may be set according to the scan-on voltage Von. The scan-on-time increases by a period when luminance non-uniformity occurs while the scan-on voltage Von is uniformly maintained. The light emission control unit 910 detects the anode current Ia generated by the electrons emitted from the electron emission regions 24 to determine if the electron emission regions 24 are deteriorated. At this point, when the luminance non-uniformity occurs due to the deterioration of the electron emission regions 24, the light emission control unit 910 increases the scan-on-time to solve the luminance non-uniformity problem. However, when the luminance non-uniformity problem is not solved even after the scan-on-time increases to a maximum level, the light emission controller gradually increases the scan-on voltage Von in response to the scan voltage control signal CVS to solve the luminance non-uniformity problem. That is, when luminance non-uniformity occurs while the scan-on-time is maintained at a maximum level, the light emission control unit 910 increases the level of the scan-on voltage Von. In the present exemplary embodiment of the present invention, the level of the scan-on voltage Von is set according to the amount of anode current and may increase step by step up to the maximum scan-on voltage Von_max, which can be obtained right before an abnormal phenomenon (such as a short circuit) occurs, considering peripheral driving elements. At this point, the scan voltage control signal CVS controls the scan driver 920 such that the scan signal having the determined scan-on voltage Von can be output. That is, the scan driver 920 selects one of the scan-on voltages in accordance with the scan voltage control signal CVS and outputs the selected voltage as the scan signal.

The process for compensating for reduced anode current Ia according to the present exemplary embodiment is substantially identical to the exemplary embodiment of FIG. 5.

In the above, although an exemplary embodiment in which the display includes a liquid crystal panel assembly is described, the present invention is not limited to this exemplary embodiment. That is, the present invention can be applied to all passive type displays that can display an image by receiving light from the light emission device.

According to embodiments of the present invention, since the time for which the driving voltage is applied increases and the driving voltage increases within a range where no luminance non-uniformity phenomenon occurs, the service life of the electron emission regions can be prolonged, and thus luminance non-uniformity can be prevented in the light emission device.

While the present invention has been illustrated and described with reference to certain exemplary embodiments, it will be understood by those of ordinary skill in the art that various modifications and changes to the described embodiments may be made without departing from the spirit and scope of the present invention as defined by the following claims.

What is claimed is:

1. A light emission device comprising:
a plurality of scan lines for transmitting a plurality of scan signals;
a plurality of column lines for transmitting a plurality of light emission data signals;
a plurality of light emission pixels defined by the scan and column lines; and
an anode electrode for receiving an anode voltage,
wherein the scan signal is transmitted to the light emission pixels in response to a first scan-on voltage and a first scan-on-time; and
wherein one of the first scan-on voltage and the first scan-on-time increases when an anode current flowing along the anode electrode is less than a first reference current.

2. The light emission device of claim 1, wherein when the anode current is less than the first reference current, the first scan-on-time increases step by step.

3. The light emission device of claim 1, wherein when the anode current is less than the first reference current, the first scan-on voltage increases step by step.

4. The light emission device of claim 1, wherein when the anode current is less than the first reference current, the first scan-on voltage increases after the first scan-on-time increases at least one time.

5. The light emission device of claim 4, wherein, when the anode current is less than the first reference current after the first scan-on-time increases to a maximum level, the first scan-on voltage increases.

6. The light emission device of claim 5, wherein when the anode current is less than the first reference current after the first scan-on voltage increases and after the first scan-on-time responds to the increased first scan-on voltage, the first scan-on-time increases to compensate for the anode current.

7. A display comprising:
a panel assembly comprising a plurality of gate lines for transmitting a plurality of gate signals, a plurality of data lines for transmitting a plurality of data signals, and a plurality of pixels defined by the gate and data lines; and
a light emission device comprising a plurality of scan lines for transmitting a plurality of scan signals, a plurality of column lines for transmitting a plurality of light emission data signals, a plurality of light emission pixels defined by the scan and column lines, and an anode electrode for receiving an anode voltage,
wherein the scan signal is transmitted to the light emission pixels in response to a first scan-on voltage and a first scan-on-time; and
wherein one of the first scan-on voltage and the first scan-on-time increases to compensate for a reduction in an anode current flowing along the anode electrode.

8. The display of claim 7, wherein the anode current is compensated for by increasing the first scan-on voltage after increasing the first scan-on-time.

9. The display of claim 8, wherein when the anode current is less than the first reference current after the first scan-on voltage increases and after the first scan-on-time responds to the increased first scan-on voltage, the first scan-on-time increases to compensate for the anode current.

10. A method of driving a light emission device comprising a first electrode, a second electrode, a plurality of light emission pixels that emit light in response to a scan signal applied to a first electrode and a signal applied to a second electrode, and a third electrode along which a current generated at the light emission pixels flows, the method comprising:
applying a first scan-on voltage to the first electrode for a first scan-on-time;
detecting the first current flowing along the third electrode;
comparing the first current with a reference current; and
increasing one of the first scan-on voltage and the first scan-on-time when the first current is less than the reference current.

11. The method of claim 10, wherein, when the first current is less than the reference current, the first scan-on-time increases.

12. The method of claim 10, wherein when the first current is less than the reference current, the first scan-on voltage increases.

13. The method of claim 12, wherein when the first current is less than the reference current after the first scan-on voltage increases and after the first scan-on-time responds to the increased first scan-on voltage, the first scan-on-time increases to compensate for the first current.
